(19) United States
(12) Patent Application Publication
(10) Pub. No.: US 2017/0015572 A1
(43) Pub. Date: Jan. 19, 2017

(54) AERATED BIOFILM REACTOR HOLLOW FIBRE MEMBRANE

(71) Applicant: University College Dublin, National University of Ireland, Dublin, Dublin (IE)

(72) Inventors: Eoin CASEY, Dublin (IE); Eoin SYRON, County Mayo (IE)

(21) Appl. No.: 15/124,927

(22) PCT Filed: Mar. 11, 2015
(86) PCT No.: PCT/EP2015/055047

§ 371 Date: Sep. 9, 2016

(30) Foreign Application Priority Data
Mar. 11, 2014 (GB) 1404274.1

(51) Int. Cl. C02F 3/10; B01D 71/70; B01D 69/08; B01D 53/22; C02F 3/12; C02F 3/20

(52) U.S. Cl. CPC C02F 3/102; C02F 3/1268; C02F 3/208; B01D 69/082; B01D 53/228; B01D 71/70

(57) ABSTRACT

The present invention is concerned with a hollow fibre membrane for use in a Membrane Supported Biofilm Reactor (MSBR) or the like, the hollow fibre membrane comprising a substantially cylindrical sidewall defining an internal lumen from which gas can permeate through the sidewall, and characterised in that at least a part of an outer surface of the fibre membrane is engineered to define at least one biofilm retaining region which acts to retain a quantity of biofilm therein, in particular when the fibre membrane is subjected to a high sheer biofilm control event, such as experienced during a reactor cleaning cycle, for removing excess biofilm in order to prevent clogging of the reactor.

### FIELD OF THE INVENTION

The present invention is concerned with a hollow fibre membrane for use in a Membrane Supported Biofilm Reactor (MSBR), or one embodiment of this reactor generally referred to as a membrane aerated biofilm reactor (MABR), and to a reactor utilising an array of such hollow fibre membranes, in particular for the large scale treatment of effluent such as municipal wastewater or the like. It will however be appreciated that the hollow fibre membrane of the invention may be used with any reactor which utilises one or more membranes to supply gas direclty to a biofilm.

### BACKGROUND OF THE INVENTION

In an MSBR, the biofilm is naturally immobilized on a gas permeable membrane. Oxygen or other gas diffuses through the membrane into the biofilm where oxidation of pollutants or biological reaction with other bio-available compounds, supplied at the biofilm-liquid interface, takes place. The gas supply rate is controlled by the intra-membrane gas partial pressure (a process parameter) and membrane surface area (a design parameter). The MABR concept is originally described in U.S. Pat. No. 4,181,604, but successful commercialization has not materialized, primarily due to the difficulty in controlling the amount of biofilm in the reactor. In particular, excessive biofilm formation is known to cause clogging/channelling in the bioreactor, particularly in hollow fibre type systems, the dominant membrane configuration.

Biofilms, which comprise a community of microorganisms attached to a surface, have long been exploited for wastewater treatment. Natural immobilization of the microbial community on inert supports allows excellent biomass retention and accumulation without the need for solid-separation devices. In the context of wastewater treatment, the ability of biofilm based processes to completely uncouple solids retention time (SRT) from hydraulic retention time (HRT) is especially useful for slow-growing organisms which would otherwise be washed out of the system, nitrifying biofilms being a case in point. Established biofilm processes, such as the trickling filter became popular in the 20^{th} century because they offered simple, reliable and stable operation. Innovation in wastewater treatment technology is driven largely by the need to meet increasingly stringent regulatory standards and by the need to reduce the capital and operating costs of treatment processes. In recent years, these drivers have prompted the emergence of improved biofilm processes such as the

Biological Aerated Filter (BAF) and the Moving Bed Biofilm Reactor (MBBR). One of the key advantages of biofilm-based processes is the potentially high volumetric reaction rate that can be attained due the high specific biomass concentration. Unfortunately, this advantage is rarely exploited in full-scale processes as a result of oxygen transfer limitations into thick biofilms. Biofilms in wastewater treatment systems are frequently thicker than the penetration depth of oxygen, typically 50 μm to 150 μm and, under high carbon-loading rates, the process becomes oxygen transfer rate limited. This problem, combined with the difficulty in controlling biofilm thickness has resulted in the application of biofilm technology predominantly for low-rate processes. Innovative technologies to overcome this problem are mainly based on methods that increase the specific surface area (particle based biofilm technologies), or on methods for increasing the oxidation capacity and efficiency, such as the membrane-aerated biofilm reactor (MABR).

The incorporation of membranes in wastewater treatment reactors can be traced back several decades when Schaffer et al (1960) reported the use of plastic films of unspecified material for oxygenation of a wastewater. Visible biological growth was observed on the polymer and it was reported that this had no observable effect on the oxygen transfer rate. It was not until 1978 when Yeh and Jenkins (1978) reported results of experiments with Teflon tubes in synthetic wastewater, that the potential of the membrane for oxygenation was recognized. This work was inspired by the emergence of hollow-fibre oxygenation systems for cell and tissue culture in the early 1970s. By 1980 the first patent was issued for a hollow fibre wastewater treatment reactor in which the biological oxidation takes place on the surface of micro-porous membranes. However, commercial exploitation of the technology has not yet emerged and until the present time there have been very limited trials of the technology beyond laboratory scale.

The MABR has several advantages over conventional biofilm technologies;
1. Comparatively high volumetric carbon oxygen demand (COD) removal rates are achievable if pure oxygen is fully exploited and if biofilm thickness-control measures are in place.
2. Bubbleless aeration offers the potential for significantly higher oxygen utilization efficiencies with consequent energy savings. In addition, reduced air stripping during the bio-treatment of volatile organic compounds is possible.
3. Simultaneous nitrification, denitrification and COD removal can be achieved at comparatively higher rates due to the unique microbial population stratification.
4. Specialist degrading microorganisms, such as ammonia oxidizing bacteria, tend to be preferentially located adjacent to the biofilm-membrane interface thereby enhancing their retention by protection from biofilm erosion.

Over a hundred research articles concerning both fundamental and applied aspects of the MABR have been published for a range of wastewater treatment application areas and the number of publications has surged dramatically in the past couple of years. The increased interest in the MABR has arisen perhaps due to a realization that it is a technology that can both achieve process intensification in wastewater treatment as well as offering the potential for significant energy cost savings.

There are a number of patents relating to MABR technology, however none of these incorporate effective biofilm control technology. EP2361367 aims to tackle the issue of biofilm control by providing the basis for determining when it is necessary to instigate the biofilm control.

To ensure the MABR can compete in the Waste Water Treatment marketplace there is a critical need to ensure that the oxygenation membranes have high oxygen permeability, are robust, cost effective and suitable for the immobilisation of biofilm. If the MABR is to achieve the potential indicated by laboratory scale trials, several technical challenges need to be overcome. The primary obstacle to full scale implementation has been the problem of excess biomass control which can lead to significant performance deterioration. In light of the method disclosed in EP2361367 to determine when biofilm control takes palace, it becomes necessary to prevent complete biofilm removal during the biofilm control procedure.

This is the paradox of the MABR, in that from a bio-catalytic point of view the more biofilm the better the reactor performs, however above a certain limit the accumulation of biofilm can cause severe problems with liquid flow distribution. The ideal MABR will operate in a cyclical manner with biofilm accumulation, partial removal and re-growth. In order to maintain the biofilm in the optimum range a mechanism to prevent complete biofilm detachment during the control operation is required. Many of the laboratory scale studies reported to-date in the literature were operated with low membrane packing densities and thus, the problem of biomass control was not prioritized. In assessing the prospect of the technology it is necessary to carefully examine the results of prior studies where modules were trialled using membrane packing densities high enough to be realistic for commercial application of MABR technology. Invariably these studies (Semmens et al, 2003, Semmens, 2005) have shown that significant clogging of the membrane module occurs, usually after several weeks or months of operation. This problem of excess biomass formation is concomitant with deterioration in the performance of the reactor in meeting its pollutant removal efficiencies.

U.S. Pat. No. 4,181,604 (issued on Jan. 1, 1980), describes a module having several loops of hollow fibre porous membranes connected at both ends to a pipe at the bottom of a tank containing wastewater. The pipe carries oxygen to the lumens of the membranes and oxygen diffuses through the membrane pores to an aerobic biofilm growing on the outer surface of the membranes. In U.S. Pat. No. 4,746,435 the same apparatus is used but the amount of oxygen containing gas is controlled to produce a biofilm having aerobic zones and anaerobic zones. U.S. Pat. No. 6,558,549 describes an apparatus for treatment of wastewater where a biofilm is cultivated on the surface of non-rigid (sheet like) planar gas transfer membranes immersed in the wastewater tank in the vertical direction. The invention is an immersion type membrane system possibly for use in wastewater retrofit applications. There is however no effective means of biofilm thickness control. An air bubble scouring method is unlikely to be effective, and may remove all of the biofilm thereby impinging process performance.

U.S. Pat. No. 5,403,479 describes an in situ cleaning system for fouled membranes. The membrane is cleaned by a cleaning fluid containing a biocide. U.S. Pat. 5,941,257 describes a method for two-phase flow hydrodynamic cleaning for piping systems. U.S. Pat. No. 7,367,346 describes a method for cleaning hollow tubing and fibres. These three patents are applied for the cleaning hemodialyzers used for dialysis and hollow fibre modules used in water treatment and separations. They are not applicable to systems where the material to be cleaned is acting as a biocatalyst and do not have any form of process sensing linked to the cleaning method.

The present invention seeks to provide an improved hollow fibre membrane for use with membrane aerated biofilm reactors.

### SUMMARY OF THE INVENTION

According to a first aspect of the present invention there is provided an aerated biofilm reactor fibre membrane comprising a substantially cylindrical sidewall defining an internal lumen from which gas can permeate through the sidewall; characterised in that at least a part of an outer surface of the fibre membrane is engineered to define at least one biofilm retaining region.

Preferably, the outer surface of the fibre membrane defines an array of the engineered biofilm retaining regions.

Preferably, the engineered biofilm retaining region of the outer surface comprises one or more concave regions.

Preferably, the engineered biofilm retaining region of the outer surface comprises one ore more substantially radially extending protrusions.

Preferably, the engineered biofilm retaining region of the outer surface comprises one ore more substantially longitudinally extending corrugations.

Preferably, the outer surface of the fibre membrane is multilateral.

Preferably, an inner surface of the fibre membrane, which defines the lumen, is shaped to optimise gas transfer through the sidewall.

Preferably, the fibre membrane is formed as a polymer extrusion.

Preferably, the fibre membrane comprises an open end through which gas may be supplied to the lumen.

Preferably, the fibre membrane has an external diameter in the range of between 0.2 mm to 5 mm, more preferably between 0.35 mm and 0.9 mm, and most preferably 0.5 mm.

Preferably, the fibre membrane comprises a gas permeable polymer.

Preferably, the fibre membrane comprises polydimethyl siloxane (PDMS).

According to a second aspect of the present invention there is provided a membrane aerated biofilm reactor comprising a plurality of hollow fibre membranes according to the first aspect of the invention.

Preferably, the reactor comprises means for supplying a gas to the lumen of the fibre membranes.

Preferably, at least an open end of each fibre membrane is captured in an anchor.

Preferably, the fibre membranes are arranged in groups.

### BRIEF DESCRIPTION OF THE DRAWINGS

FIG. 1 illustrates a cross section of an conventional prior art hollow fibre for use in a membrane aerated biofilm reactor;

FIG. 2 illustrates a cross section of an aerated biofilm reactor membrane fibre according to a preferred embodiment of the present invention;

FIG. 3 illustrates a cross section of an alternative aerated biofilm reactor membrane fibre according to a preferred embodiment of the present invention;

FIG. 4 illustrates a cross section of another alternative aerated biofilm reactor membrane fibre according to a preferred embodiment of the present invention;

FIG. 5 illustrates a cross section of another alternative aerated biofilm reactor membrane fibre according to a preferred embodiment of the present invention

FIG. 6 illustrates a cross section of another alternative aerated biofilm reactor membrane fibre according to a preferred embodiment of the present invention

FIG. 7 illustrates a cross section of another alternative aerated biofilm reactor membrane fibre according to a preferred embodiment of the present invention; and

FIG. 8 illustrates a cross section of another alternative aerated biofilm reactor membrane fibre according to a preferred embodiment of the present invention.

### DETAILED DESCRIPTION OF THE DRAWINGS

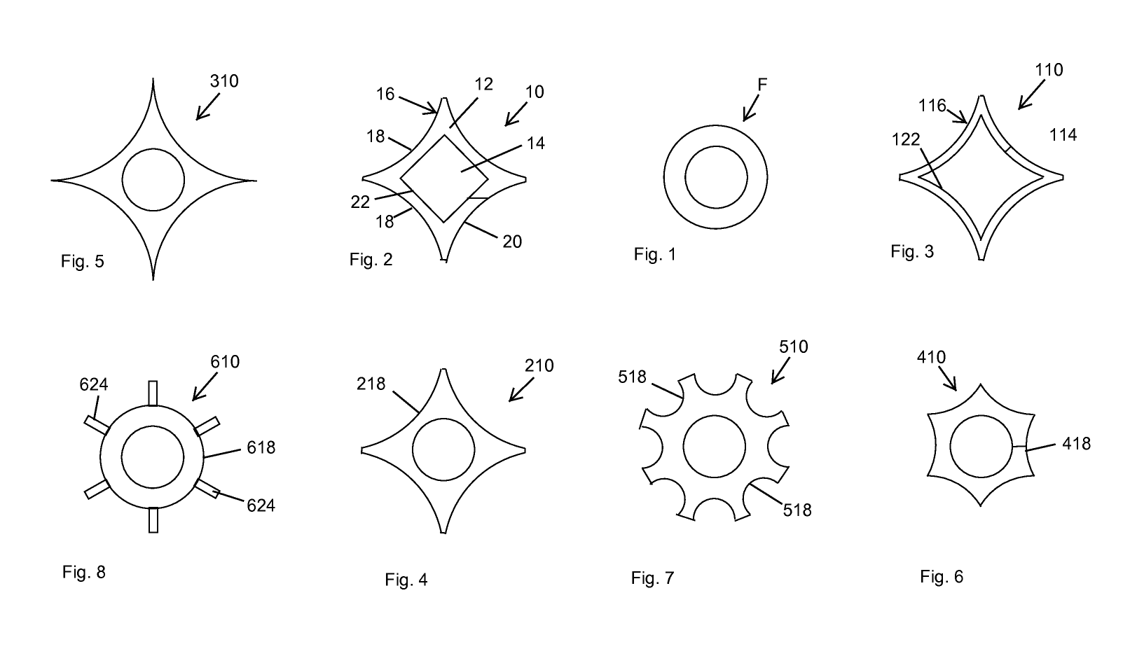

Referring now to FIG. 1 there is shown a cross-section of a conventional prior art hollow fibre F for use in a membrane aerated biofilm reactor (not shown). The hollow fibre F is substantially cylindrical in cross-section and defines an interior lumen L through which gas such as oxygen, air, oxygen enriched air, hydrogen or any other suitable gas, may be supplied, and which then permeates through the sidewall of the hollow fibre F in order to, in use, oxygenate a biofilm colonising the outer surface of the hollow fibre F. It can be seen that the outer surface of the hollow fibre F is a substantially smooth and continuous surface.

Turning then to FIG. 2 there is illustrated a cross-section of a fibre membrane for use in a membrane aerated biofilm reactor (not shown), the fibre membrane being generally indicated as 10. The fibre membrane 10 comprises a substantially cylindrical side wall 12 which is annular in form, and thus defines an interior lumen 14 which extends longitudinally of the fibre membrane 10. In use a gas such as oxygen or the like is pumped into the lumen 14 and, by providing the sidewall 12 as a gas permeable material, the gas can permeate through the sidewall 12 to be supplied to a biofilm (not shown) colonizing an outer surface 16 of the fibre membrane 10. Unlike prior art hollow fibres, the fibre membrane 10 of the present invention defines one or more, and preferably a plurality of, engineered biofilm retaining regions 18 which, as described in detail hereinafter, act to retain a quantity of biofilm therein, in particular when the fibre membrane 10 is subjected to a high sheer biofilm control event, such as experienced during a reactor cleaning cycle, for removing excess biofilm in order to prevent clogging of the reactor. As a result, once such an event has been completed, the biofilm held in the retaining regions 18 ensure expedient regrowth of the biofilm to full operational levels, thus significantly reducing the lead time between such a cleaning event and a return to full operation of the reactor. Conventionally this would be a significantly longer period in order to facilitate reseeding of the biofilm and regrowth on the outer surface of the fibre to an operational level.

Unlike prior art fibres, in the FIG. 2 embodiment the outer surface 16 is multilateral, and includes four concave sides 20, each of which defines a single biofilm retaining region 18. It can be seen that the inner surface 22 of the sidewall 12 is also multilateral, corresponding in number of sides to that of the outer surface 16, although each of the sides are relatively flat as opposed to the concave sides 20 of the outer surface 16. It will however be appreciated that the shape of both the outer surface 16 and inner surface 22 may be varied as required. For example it may be preferable that the outer surface 16 and inner surface 22 are substantially parallel in order to provide the side wall 12 with a substantially uniform thickness, thereby ensuring an equal transfer of gas at all points around the side wall 12, in order to establish an equal growth rate of biofilm about the outer surface 16. Equally however it will understood that it may be desirable to encourage regions of increased or decreased biofilm thickness on the outer surface 16, by suitably altering the gas permeability of that region of the sidewall 12, for example by varying the thickness of the sidewall 12 at localised regions. The fibre membrane 12 preferably has a external diameter in the range of between 0.2 mm to 5 mm, more preferably between 0.35 mm and 0.9 mm, and most preferably 0.5 mm, which diameter is measured at the radially outmost extremity of the fibre membrane 12.

The fibre membrane 12 is preferably produced by extruding a polymer through a suitably shaped die (not shown) to provide the desired external and internal profiles to the fibre membrane 10. It will however be immediately understood that any other suitable method of manufacturing the fibre membrane 10 may be employed, and the material or combination of materials selected to form the fibre membrane 10 may be varied. The fibre membrane 12 is preferably comprised of silicone (polydimethyl siloxane (PDMS)) Or a modified version of PDMS, although other suitable materials may be employed.

Referring to FIGS. 3 to 8 there are illustrated alternative embodiments of a fibre membrane according to the present invention and for use in a MABR, each variant providing an alternative sidewall profile, as dictated by the shape of an outer surface and/or an inner surface of the respective fibre membrane.

In particular, referring to FIG. 3 there is illustrated a fibre membrane 110 similar in cross-section to the fibre membrane 10 of the first embodiment. However, an outer surface 116 and an inner surface 122 are substantially parallel with one another, thus providing the side wall 112 with a substantially uniform thickness.

FIG. 4 illustrates a fibre membrane 210 having a multilateral outer surface 216 and a substantially circular inner surface 222 defining an interior lumen 214.

The cross-section illustrated in FIG. 5 is similar to that shown in FIG. 4, illustrating a fibre membrane 310 having a multilateral outer surface 316 comprising four concave sides 320 which each define a biofilm retaining region 318, separated from one another by a more pronounced or sharp apex. An inner surface 322 is substantially circular in cross-section.

The cross-section of illustrated in FIG. 6 illustrates a fibre membrane 410 which is again multi-lateral in form, defining six concave sides 420 and a substantially circular inner surface 422.

Turning to FIG. 7, there is illustrated a fibre membrane 510 having an outer surface 516 from which protrude a plurality of substantially radially extending projections 524 between adjacent pairs of which are thus defined a biofilm retaining region 518 in the form of a concave corrugation 520, each of which extends substantially longitudinally of the fibre membrane 510.

FIG. 8 illustrates a further alternative fibre membrane 610 which comprises a side wall 612 having a substantially circular outer surface 616 and a substantially circular inner surface 622. However the side wall 612 is further provided with a circular array of substantially radially extending protrusions 624 between adjacent pairs of which are thus defined biofilm retaining regions 618 which extend substantially longitudinally of the fibre membrane 610.

In each of the above fibre membranes at least one, and preferably an array of, biofilm retaining regions are defined about an outer surface of the fibre membrane, such that during a high sheer event such as a biofilm purge in order to prevent clogging of a reactor, some level of biofilm is retained in the retaining regions on the outer surface of each fibres membrane, in order to facilitate a speedy regrowth of the biofilm following the high shear event, in order to allow the reactor to be fully operational in a reduced period of time.

1. An aerated biofilm reactor fibre membrane comprising a substantially cylindrical sidewall defining an internal lumen from which gas can permeate through the sidewall, wherein at least a part of an outer surface of the fibre membrane is engineered to define at least one biofilm retaining region.

2. The fibre membrane according to claim 1, wherein the outer surface of the fibre membrane defines an array of the engineered biofilm retaining regions.

3. The fibre membrane according to claim 1, wherein the engineered biofilm retaining region of the outer surface comprises one or more concave regions.

4. The fibre membrane according to claim 1, wherein the engineered biofilm retaining region of the outer surface comprises one or more substantially radially extending protrusions.

5. The fibre membrane according to claim 1, wherein the engineered biofilm retaining region of the outer surface comprises one or more substantially longitudinally extending corrugations.

6. The fibre membrane according to claim 1, wherein the outer surface of the fibre membrane is multilateral.

7. The fibre membrane according to claim 1, wherein an inner surface of the fibre membrane, which defines the lumen, is shaped to optimise gas transfer through the sidewall.

8. The fibre membrane according to claim 1, wherein the fibre membrane is formed as a polymer extrusion.

9. The fibre membrane according to claim 1, wherein the fibre membrane comprises an open end opposed the close end and through which gas may be supplied to the lumen.

10. The fibre membrane according to claim 1, wherein the fibre membrane has an external diameter in the range of between 0.2 mm to 5 mm, more preferably between 0.35 mm and 0.9 mm, and most preferably 0.5 mm.

11. The fibre membrane according to claim 1, wherein the fibre membrane comprises a gas permeable polymer.

12. The fibre membrane according to claim 1, wherein the fibre membrane comprises polydimethyl siloxane (PDMS).

13. A membrane aerated biofilm reactor comprising a plurality of hollow fibre membranes according to claim 1.

14. The membrane aerated biofilm reactor according to claim 13, comprising means for supplying a gas to the lumen of one or more of the fibre membranes.

15. The membrane aerated biofilm reactor according to claim 14, wherein at least an open end of each fibre membrane is captured in an anchor.

16. The membrane aerated biofilm reactor according to claim 14, wherein the fibre membranes are arranged in groups.

17. An aerated biofilm reactor fibre membrane, the fibre membrane comprising:
a substantially cylindrical sidewall defining an internal lumen from which gas can permeate through the sidewall, the lumen including an inner surface;
an outer surface, at least a part of the outer surface of the fibre membrane being engineered to define an array of engineered biofilm retaining regions;
a closed end; and
an open end opposite the closed end, the open end being configured to allow a gas to pass through the open end into the internal lumen.

18. The aerated biofilm reactor fibre membrane of claim 17, wherein the inner surface of the lumen is shaped to optimise gas transfer through the sidewall.

19. The aerated biofilm reactor fibre membrane of claim 17, wherein the array of engineered biofilm retaining includes at least one of:
at least one concave region;
at least one substantially radially extending protrusion; and
at least one substantially longitudinally extending corrugation.

20. A membrane aerated biofilm reactor, the reactor comprising:
a plurality of hollow fibre membranes, each fibre membrane comprising:
a substantially cylindrical sidewall defining an internal lumen from which gas can permeate through the sidewall, the lumen including an inner surface;
an outer surface, at least a part of the outer surface of the fibre membrane being engineered to define an array of engineered biofilm retaining regions, the array of engineered biofilm retaining regions including at least one of:
at least one concave region;
at least one substantially radially extending protrusion; and
at least one substantially longitudinally extending corrugation;
a closed end; and
an open end opposite the closed end, the open end being captured in an anchor and being configured to allow a gas to pass through the open end into the internal lumen,
each fibre membrane being composed of a gas permeable polymer and formed as a polymer extrusion;
the plurality of fibre membranes being arranged in a plurality of groups;
each fibre membrane having an external diameter in the range of between 0.35 mm and 0.9 mm; and
a means for supplying a gas to the internal lumen of each of the plurality of fibre membranes.
